(19) United States
(12) Patent Application Publication
(10) Pub. No.: US 2020/0129911 A1
(43) Pub. Date: Apr. 30, 2020

(54) FILTER WITH SEPARATOR PLATES WITH SPECIAL FOLDING

(71) Applicant: Carl Freudenberg KG, Weinheim (DE)

(72) Inventors: Christian Ewald, Rimbach (DE); Renate Tapper, Bensheim (DE); Juergen Becker, Zeiskam (DE)

(21) Appl. No.: 16/660,849

(22) Filed: Oct. 23, 2019

(30) Foreign Application Priority Data
Oct. 25, 2018 (EP) 18202450.5

(51) Int. Cl. B01D 46/52

(52) U.S. Cl. CPC B01D 46/523; B01D 39/2017; B01D 46/522

(57) ABSTRACT

A filter for purifying air includes a frame, layers of a filter medium, and separator plates. The layers of the filter medium and the separator plates are arranged in the frame. The layers of the filter medium are aligned at a distance from each other and one of the separator plates is arranged between each two layers of the filter medium. The separator plates are folded and are provided with folding in such a way that the separator plate is designed with a number of fold peaks and fold valleys on its first side and a multiple number of fold peaks and fold valleys on its other, second side. The fold peaks and fold valleys extend from the first side to the second side. The folding, as viewed in the flow direction, causes a trapezoidal cross-section of a respective separator plate.

### CROSS-REFERENCE

Priority is claimed to European Application No. EP 18 202 450.5, which was filed on Oct. 25, 2018, and is hereby incorporated by reference herein.

### FIELD

The present invention relates to a filter. The filter can be for purifying air and include one or more separator plates.

### BACKGROUND

Filters in the form of cassettes are known from the prior art. In WO 2017/008827 A1, a high temperature cassette filter is shown as a HEPA filter. The filter has a plurality of layers of filter medium arranged in parallel to one another. Separators are used to keep the layers at a distance to each other. The separators consist of zigzag-shaped, structured metal plates or metal foils made of aluminum or stainless steel. It is known that the metal separators can be folded (e.g. pleated), fluted or corrugated.

### SUMMARY

In an embodiment, the present invention provides a filter for purifying air, which includes a frame, layers of a filter medium, and separator plates. The layers of the filter medium and the separator plates are arranged in the frame. The layers of the filter medium are aligned at a distance from each other and one of the separator plates is arranged between each two layers of the filter medium. The separator plates are folded and are provided with folding in such a way that the separator plate is designed with a number of fold peaks and fold valleys on its first side and a multiple number of fold peaks and fold valleys on its other, second side. The fold peaks and fold valleys extend from the first side to the second side. The folding, as viewed in the flow direction, causes a trapezoidal cross-section of a respective separator plate. The height of the separator plate decreases from the first side toward the second side.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a separator plate for a filter according to an embodiment of the invention.

FIG. 2a-b show the arrangement of the separator plates with the filter medium for a filter in an overview representation according to an embodiment.

FIG. 3 shows different structures of the separator plate according to an embodiment.

FIG. 4 shows the folding of the separator plate on the first and second side according to an embodiment.

FIG. 5 shows a simplified side view of the separator plate according to an embodiment.

FIG. 6 shows a filter according to an embodiment of the invention.

### DETAILED DESCRIPTION

A general disadvantage of using known separators is that they influence the air flow along the filter medium and increase the loss of pressure in the filter. A further disadvantage of the known separators is that they are designed rectangularly, which results in a shape of the filter medium which is unfavorable for the flow. This also results in corners, around which the filter medium has to be guided. It is important that the filter medium fits well against the separators and is supported by the separators. If the filter material is brittle, such as a fiberglass medium, it can easily be mechanically damaged.

An embodiment of the present invention provides a filter which has a reduced pressure loss at a comparable volumetric flow and at least diminishes the disadvantages of the prior art. The embodiment can create a filter suitable for high-temperature applications. The embodiment can ensure particularly good support of the filter medium. The embodiment can be provided as a filter for purifying air, which includes a frame, layers of a filter medium, and separator plates. The layers of the filter medium and the separator plates are arranged in the frame. The layers of the filter medium are aligned at a distance from each other and one of the separator plates is arranged between each two layers of the filter medium. The separator plates are folded and are provided with folding in such a way that the separator plate (e.g., each of the separator plates or at least one of the separator plates) is designed with a number of fold peaks and fold valleys on its first side and a multiple number of fold peaks and fold valleys on its other, second side. The fold peaks and fold valleys extend from the first side to the second side. The folding, as viewed in the flow direction, causes a trapezoidal cross-section of a respective separator plate. The height of the separator plate decreases from the first side toward the second side.

An embodiment of a filter according to the invention is used to purify the air flowing through it and has a housing and layers of a filter medium as well as separator plates arranged within the housing, wherein the layers of the filter medium are aligned predominantly approximately in the flow direction and one separator plate is arranged between each two layers of the filter medium and acts as a spacer between the two layers of the filter medium. The separator plates of the filter are fluted, corrugated or folded, e.g. pleated, across their surface and consist in particular of a thick foil or a thin plate. The term “plate” is thus also understood here to mean a thicker foil. The height of the fluting, corrugation or folding then causes the distance between the two layers of the filter medium. Regardless of whether fluting, corrugation or folds structure the separator plate, this can be conveyed in the description with the term “folds” or “folding.”

According to an embodiment of the invention, it has been recognized as advantageous to provide the separator plates with a special folding. In this case, in addition to a classical folding, folding is also understood to mean fluting or corrugation. In an advantageous manner, this can improve the flow conditions of the air in the filter and, in particular, reduce the flow resistance. At the same time, a maximum dust storage capacity of the filter is ensured. The filter performance can be improved by improving the flow behavior and reducing the loss of pressure in the filter.

In an embodiment, the folding in the separator plates is characterized in that an oblique, i.e. non-parallel, fluting, corrugation or folding is present. The folding in this case is such that the separator plate is provided with a number x of fold peaks and fold valleys on its first side and a multiple number y of fold peaks and fold valleys is present on the other, second side. In particular, n is a natural number and y=n·x applies where n=2, 3, 4 . . . The fold peaks and fold valleys then extend from the first side A to the other, second side B.

With this embodiment, the stability of the separator plate can be improved. The flow behavior in the filter can also be improved and the filtration resistance of the filter can be reduced.

In this context, a fold peak is understood to mean the highest point of the fluting, corrugation or folding. A fold valley, on the other hand, is understood to mean the lowest point of a fluting, corrugation or folding.

Since the folding runs across the entire width of the separator plate, a trapezoidal cross-section of the respective separator plate results as viewed in the flow direction. In other words, in the side view of the separator plate, a trapezoid results, in particular an isosceles, symmetrical trapezoid. This means that the height of the separator plate becomes smaller from a first side A toward the other, second side B. This property does not concern the thickness of the plate from which the separator plate is formed but the height of the separator plate, i.e. the “height difference” between the fold peak and fold valley. The continuous change in the height of the separator plate allows a respective layer of a filter medium to abut the separator plate completely from the first side up to the second side, and the filter medium can thus be supported well. This is particularly important in high-temperature filters.

It has been found to be particularly advantageous that a respective separator plate has a rectangular shape in plan view. This shape can be used easily in the rectangular frame of a filter.

It was found to be particularly advantageous that the number of fold peaks and fold valleys of a respective separator plate on one side corresponds to four to ten times the number of fold peaks and fold valleys on the other side, i.e. y=4 to 10·x. Such a filter represents a particularly advantageous embodiment, since this ratio results in a particularly low loss of pressure in the filter, and an optimized flow behavior of the filter is present, wherein at the same time the stability of the separator plate remains ensured.

It has further been recognized as particularly advantageous that the height of the separator plate on the first side (A) is in the range of h_{A}=4 to 10 mm and on the second side (B) in the range of h_{B}=1 to 4 mm, in particular in the range of h_{A}=5 to 7 mm and h_{B}=1 to 2 mm. For the last-mentioned values, a particularly low flow resistance of the filter was measured.

In a particularly advantageous embodiment, the elongated length of a respective separator plate on the first side (A) is the same as on the second side (B). Elongated length means the length of the separator plate when the folds are removed and a flat plate is created. That is to say, the starting material of the separator plate may be a conventional rectangular plate or a portion of a sheet metal plate having parallel sheet edges. This enables a particularly cost-effective production of the separator plates.

In an advantageous development of the filter according to the invention, the separator plates are provided with at least one curled edge, that is to say, the plate is folded over at least once in the region of the edge. This is used for stiffening the edge and for stabilizing the separator plate. Thanks to the curled edge, a plate of lower thickness and unchanged stability can be used to produce the separator plates.

It is particularly advantageous if the separator plates are made of aluminum. Separator plates of this type are relatively light and at the same time have good stability and strength.

In a particularly advantageous embodiment of the filter, the filter medium is pleated and/or a fiberglass medium, for example a fiberglass paper or a micro-fiberglass paper. Such a filter advantageously has a large effective filtration surface and can also be used at higher temperatures of the air to be filtered.

The filter may advantageously be a cassette filter. In particular, a HEPA filter for use in clean room facilities in the food and pharmaceutical industries, microchip manufacturing or in clinics.

The filter could also be designed as a high-temperature filter for applications above 100 degrees Celsius. For this purpose, aluminum can be used as the material for the separators and a fiberglass paper can be used as the filter material. Such a high-temperature filter can be used, for example, in industrial drying systems, such as paint drying systems in the automotive industry.

An embodiment of the invention also relates to a method for producing a separator plate for a filter as described above. According to this method, the processing of a plate in a processing machine can be carried out in one run: During the fluting, corrugation or folding of a plate, the special, above-described fold is introduced into the plate. An in-line process of this type advantageously permits a particularly cost-effective production of the separator plates. As the starting material, either a plate in flat form (i.e. in plate form) or in roll form (i.e. a long rolled band) can be used. If a plate in roll form is used, it must be cut to length and the separator plate must thus be cut to the correct length.

The described embodiments of invention and the described advantageous developments of embodiments of the invention in combination with one another constitute advantageous developments of the invention.

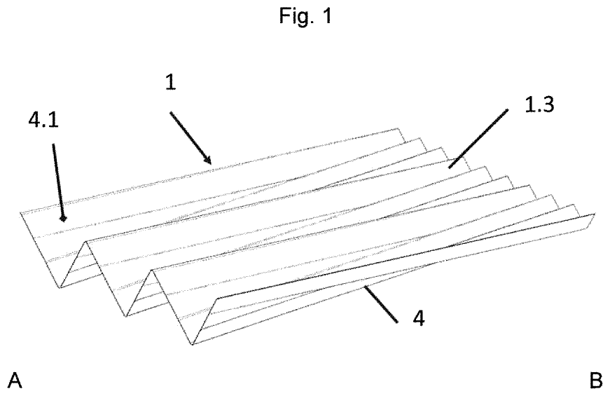

In FIG. 1, a separator plate 4 for a filter 10 according to the invention is shown. The separator plate 4 is provided across its surface with a folding 1. Compared to known separator plates, the separator plate 4 is provided with a special folding 1.3.

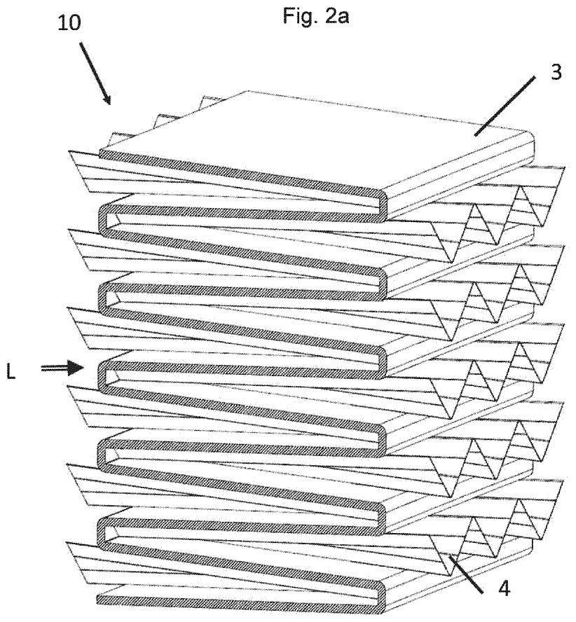

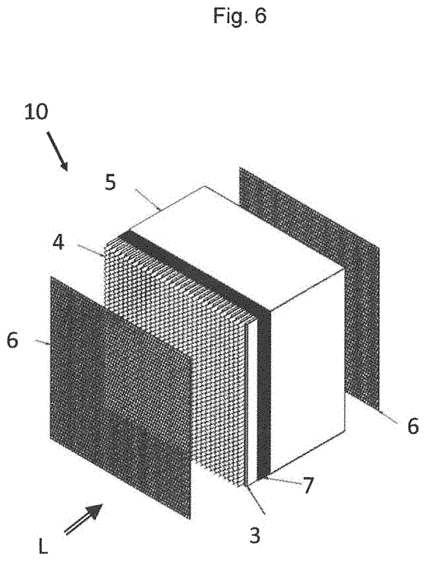

Such a separator plate 4 may be employed in a filter 10 in an arrangement, as shown in FIG. 2a and b. The filter 10 has a plurality of layers of filter medium 3 which are arranged approximately in the flow direction of the air flow L in a frame 5 (see FIG. 6). The layers are formed by a long web of the filter medium. Between each two layers of the filter medium 3, a separator plate 4 is attached which acts as a spacer between the two layers of the filter medium 3 so that two layers of the filter medium 3 do not abut against each other, but rather an airflow L can always be guided through the layers of the filter medium 3 and the air flow L can thereby be filtered. The filter 10 depicted in FIG. 2 and FIG. 6 is installed for its use in a filter receiver (not shown). As can be recognized from FIG. 2b, layers of the filter medium 3 are placed around the separator plates 4. The separator plates 4 are arranged at an offset from one another of 180°.

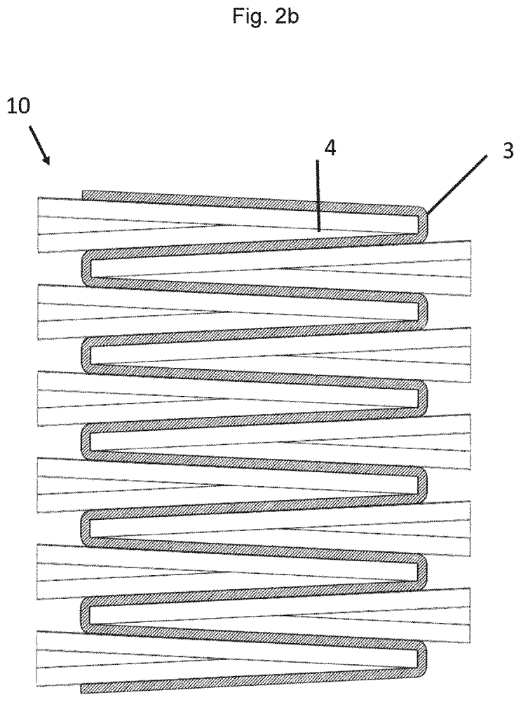

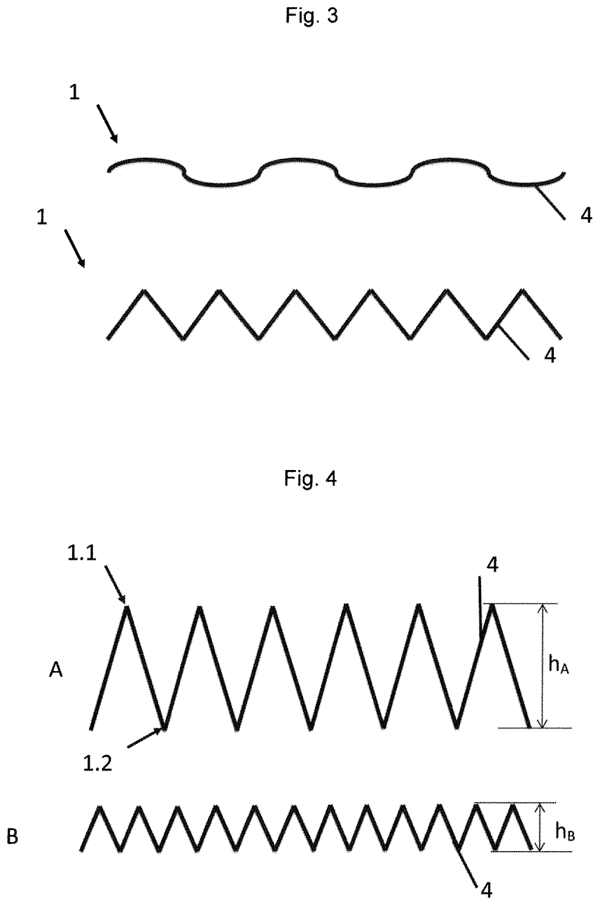

The separator plate 4 (see FIG. 1 and FIG. 4) has a folding 1 so that a plurality of fold peaks 1.1 and fold valleys 1.2 are formed. As an alternative to a folding 1, the separator plate 4 could also be provided with fluting or corrugation, as shown in FIG. 3. The separator plate 4 has either a fluting or corrugation 1 (upper illustration) or a folding 1 (lower illustration).

The folding 1 is not a known Leporello folding or zigzag folding, which is commonly also referred to as pleating and which has nothing but rectangular fold sections of equal size. Instead, the folding 1 is embodied as a special folding 1.3 so that an oblique, i.e. non-parallel, folding of the separator plate 4 results. The fold 1.3 is such that a first number of fold peaks 1.1 and fold valleys 1.2 is present on the first side A, wherein a multiple number of fold peaks 1.1 and fold valleys 1.2 is formed on the other, second side B. This can be expressed by the formula y=n·x with y as the number of fold peaks and fold valleys on the second side and x as the number on the first side, and n is a natural number where n=2, 3, 4 . . . In the embodiment illustrated in FIG. 1, n=3 was selected, which means there are three times the number of fold peaks and fold valleys 1.1 and 1.2 on the second side B compared to the first side A.

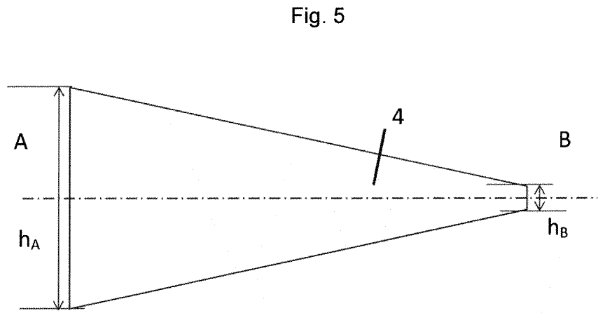

How the number of fold peaks 1.1 and fold valleys 1.2 on the first side A and the second side B of the separator plate 4 differ is shown in FIG. 4. In the upper illustration of FIG. 4, the view of the folding of the separator plate 4 on the first side A is shown. In the lower illustration of FIG. 4, the view of the folding of the separator plate 4 on the second side B is shown. The different number of fold peaks 1.1 and fold valleys 1.2 on the first side A and the second side B results in the height h_{A} of the separator plate on the first side A being greater than the height h_{B} of the separator plate 4 on the second side B. The height h_{A} or h_{B} means in each case the “height difference” between a fold valley 1.2 and a fold peak 1.1. The different number of fold peaks 1.1 and fold valleys 1.2 and the different height h_{A} and h_{B} of the separator plate 4 then results in a trapezoidal cross-section of the separator plate 4 as shown in FIG. 5 when the fold 1.3 extends over the entire width of the separator plate 4 (i.e. from A to B). This configuration of the separator plate 4 improves the flow behavior in the filter 10 and reduces the filtration resistance of the filter 10.

In particular, adjacent separator plates 4 can be arranged at an offset from one another of 180 degrees, as shown in FIG. 2 and FIG. 6.

In FIG. 6, by way of example, a filter 10 according to the invention is shown in an exploded view.

The filter 10 has a frame 5, in which a plurality of layers of filter medium 3 is arranged and through which an air flow L can flow, and the air flow L can thereby be purified. Between each two layers of the filter medium 3, a separator plate 4 described on the basis of the other figures is positioned in each case, which prevents two layers of the filter medium 3 from abutting each other. In order to protect the filter medium and hold it in the filter 10, metal grating is provided on the two open sides of the filter 10. A seal 7 is arranged between the frame 5 and the filter medium 3 and prevents leakage between the filter medium 3 and the frame 5.

Disclosed is a filter (10) for purifying air (L), comprising a frame (5), layers of a filter medium (3) as well as separator plates (4) arranged in the frame (5), wherein the layers of the filter medium (3) are aligned at a distance from each other and one separator plate (4) is arranged between each two layers of the filter medium (3), wherein the separator plates (4) are folded. According to an embodiment, the separator plates (4) are provided with a special folding (1.3) in such a way that the separator plate (4) is designed with a number of fold peaks (1.1) and fold valleys (1.2) on one side (A) and a multiple number of fold peaks (1.1) and fold valleys (1.2) on the other side (B).

In an advantageous manner, this can improve the flow conditions of the air in the filter (10) and, in particular, reduce the flow resistance. At the same time, a maximum dust storage capacity of the filter (10) is ensured. Disclosed is a method for producing a separator plate (4) for such a filter (10).

Disclosed is a filter (10) for purifying air (L), comprising a frame (5), layers of a filter medium (3) as well as separator plates (4) arranged in the frame (5), wherein the layers of the filter medium (3) are aligned at a distance from each other and one separator plate (4) is arranged between each two layers of the filter medium (3), wherein the separator plates (4) are folded. Disclosed is a method of making such a filter, wherein during fluting, corrugation, or pleating of a plate, the folding is introduced into the plate.

### LIST OF REFERENCE SIGNS

1 Folding/fluting/corrugation

1.1 Fold peak

1.2 Fold valley

1.3 Special folding

3 Layer of filter medium

4 Separator plate

4.1 Plate

5 Frame

6 Metal grating

7 Seal

10 Filter

A First side

B Second side

L Air flow

h_{A,B} Height of the separator plate

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A filter for purifying air, the filter comprising:
a frame;
layers of a filter medium; and
separator plates;
wherein the layers of the filter medium and the separator plates are arranged in the frame, wherein the layers of the filter medium are aligned at a distance from each other and one of the separator plates is arranged between each two layers of the filter medium;
wherein the separator plates are folded and are provided with folding in such a way that the separator plate is designed with a number of fold peaks and fold valleys on its first side and a multiple number of fold peaks and fold valleys on its other, second side, wherein the fold peaks and fold valleys extend from the first side to the second side, and wherein the folding, as viewed in the flow direction, causes a trapezoidal cross-section of a respective separator plate and the height of the separator plate decreases from the first side toward the second side.

2. The filter according to claim 1, wherein the number of fold peaks and fold valleys on the second side corresponds to four to ten times the number of the fold peaks and fold valleys on the first side.

3. The filter according to claim 1, wherein the folded separator plate in the side view has the shape of an isosceles, symmetrical trapezoid.

4. The filter according claim 1, wherein the height of the separator plate on the first side is in the range of 4-10 mm and on the second side is in the range of 1-4 mm.

5. The filter according to claim 1, wherein the height of the separator plate on the first side is in the range of 5-7 mm and the height of the separate plate on the second side is in the range of 1-2 mm.

6. The filter according to claim 1, wherein the elongated length of a respective separator plate on the first side is the same as on the second side.

7. The filter according to claim 1, wherein the separator plates are provided with at least one curled edge.

8. The filter according to claim 1, wherein the separator plates are made of aluminum.

9. The filter according to claim 1, wherein the filter medium is a fiberglass medium.

10. The filter according to claim 1, wherein the filter is a cassette filter and/or the filter is designed as a high-temperature filter.

11. A method for producing a separator plate for a filter according to claim 1, wherein during fluting, corrugation or pleating of a plate, the folding is introduced into the plate.

12. A filter for purifying air, the filter comprising:
a frame;
folded separator plates arranged in the frame, each of the separator plates being folded such that the respective separator plate includes fold peaks and fold valleys on a first side and fold peaks and fold valleys on a second side, the fold peaks and fold valleys extend from the first side to the second side, and the folding, as viewed in a direction of flow, causes a trapezoidal cross-section of the respective separator plate and a height of the respective separator plate decreases from the first side toward the second side; and
layers of a filter medium arranged in the frame, the layers of the filter medium being aligned at a distance from each other and a respective one of the separator plates being arranged between each set of two consecutive layers of the filter medium.
